(19) United States
(12) Patent Application Publication
(10) Pub. No.: US 2016/0224553 A1
(43) Pub. Date: Aug. 4, 2016

(54) SEARCH METHODS AND TERMINALS

(71) Applicant: BEIJING ZHIGU RUI TUO TECH CO., LTD, Beijing (CN)

(72) Inventor: Kuifei Yu, Beijing (CN)

(21) Appl. No.: 15/021,267

(22) PCT Filed: Sep. 9, 2014
(86) PCT No.: PCT/CN2014/086138

§ 371 Date: Mar. 10, 2016

(30) Foreign Application Priority Data
Sep. 12, 2013 (CN) 201310413702.8

(51) Int. Cl. G06F 17/30; G06F 3/0481; G06F 3/0484; H04L 29/08

(52) U.S. Cl. CPC G06F 17/30038; G06F 17/30545; G06F 17/30887; H04L 67/02; G06F 3/0481; G06F 3/04842

(57) ABSTRACT

The present application provides search methods and terminals, relating to the field of communications. A method comprises: selecting a search object in a media resource according to an input instruction, acquiring attribute information and environment information of the search object, and sending the attribute information and environment information of the search object to a server. In an aspect, attribute information and environment information of a search object are sent to a server, and the server side calculates content of the search object and context of the search object according to the attribute information and environment information of the search object, thereby accomplishing a searching task, avoiding both the content of the search object and the context of the search object being sent to the server. Therefore, data traffic and electric energy loss on the terminal side during data communication are reduced while high search efficiency is ensured.

### RELATED APPLICATION

The present international patent cooperative treaty (PCT) application claims the benefit of priority to Chinese Patent Application No. 201310413702.8, filed on Sep. 12, 2013, and entitled “Search Methods and Terminals”, which is hereby incorporated into the present international PCT application by reference herein in its entirety.

### TECHNICAL FIELD

The present application relates to the field of communications technologies, and, in particular, to various search methods and terminals.

### BACKGROUND

With the popularization of mobile terminals, various mobile terminals, such as mobile phones and tablet computers, appear in people's daily life. People use mobile terminals to browse web pages more often, and may perform searching while browsing web pages.

In an existing search method, a mobile terminal usually sends a search object to a server directly, and the server sends a search result to the mobile terminal after the search is completed. However, a highly efficient search not only relies on the search object, but also relies on context of the search object. Therefore, in some context-based search methods, both a search object and context of the search object are sent to a server; the server obtains a search result based on the search object and the context of the search object, and then sends the search result to the mobile terminal.

In the foregoing context-based search method, because a mobile terminal sends a search object together with context of the search object to a server, large data traffic is generated, and in addition, great electric energy loss is caused, which reduces the battery life of the mobile terminal.

### SUMMARY

Application objectives of the present application are to provide various search methods and terminals, so as to reduce data traffic while ensuring high search efficiency.

According to one example embodiment of the embodiments of the present application,

a search method is provided, comprising:

selecting a search object in a media resource according to an input instruction,

acquiring attribute information and environment information of the search object, and

sending the attribute information and environment information of the search object to a server.

According to another example embodiment of the embodiments of the present application, a search terminal is provided, comprising:

an object selection unit configured to select a search object in a media resource according to an input instruction,

an information acquisition unit configured to acquire attribute information and environment information of the search object, and

a communication unit, configured to send the attribute information and environment information of the search object to a server.

According to another example embodiment of the present application, provided is a computer readable storage device, the computer readable storage device comprising at least one executable instruction, which, in response to execution, causes a search terminal comprising a processor to perform operations, comprising:

selecting a search object in a media resource according to an input instruction,

acquiring attribute information and environment information of the search object, and

sending the attribute information and environment information of the search object to a server.

According to another example embodiment of the present application, provided is a search terminal, the search terminal comprising a processor and a memory, the memory storing computer executable instructions, the processor being connected to the memory via a communication bus, and when the search terminal operates, the processor executes the computer executable instructions stored in the memory, so that the search terminal executes operations, comprising:

selecting a search object in a media resource according to an input instruction,

acquiring attribute information and environment information of the search object, and

sending the attribute information and environment information of the search object to a server.

In the various search methods and terminals according to the present application, only attribute information and environment information of a search object are sent to a server, and the server calculates content of the search object and context of the search object according to the attribute information and environment information of the search object, thereby accomplishing a searching task. It is avoided that both the content of the search object and the context of the search object are sent to the server. Therefore, data traffic is reduced while high search efficiency is ensured, and moreover, electric energy loss on the terminal side during data communication is reduced.

### BRIEF DESCRIPTION OF THE DRAWINGS

FIG. 1 is an example flowchart of a search method according to an embodiment of the present application;

FIG. 2a is an example schematic diagram of a type of area information of a search object according to an embodiment of the present application;

FIG. 2b is an example schematic diagram of another type of area information of a search object according to an embodiment of the present application;

FIG. 2b is an example schematic diagram of still another type of area information of a search object according to an embodiment of the present application;

FIG. 3 is an example flowchart of another search method according to an embodiment of the present application;

FIG. 4 is an example schematic structural diagram of modules of a search terminal according to an embodiment of the present application;

FIG. 5 is another example schematic structural diagram of modules of a search terminal according to an embodiment of the present application;

FIG. 6 is still another example schematic structural diagram of modules of a search terminal according to an embodiment of the present application; and

FIG. 7 is an example schematic structural diagram of hardware of a search terminal according to an embodiment of the present application.

### DETAILED DESCRIPTION

The following describes the specific implementation manners of the present application in further detail with reference to the accompanying drawings and embodiments. The following embodiments are used for describing the present application, but are not intended to limit the scope of the present application.

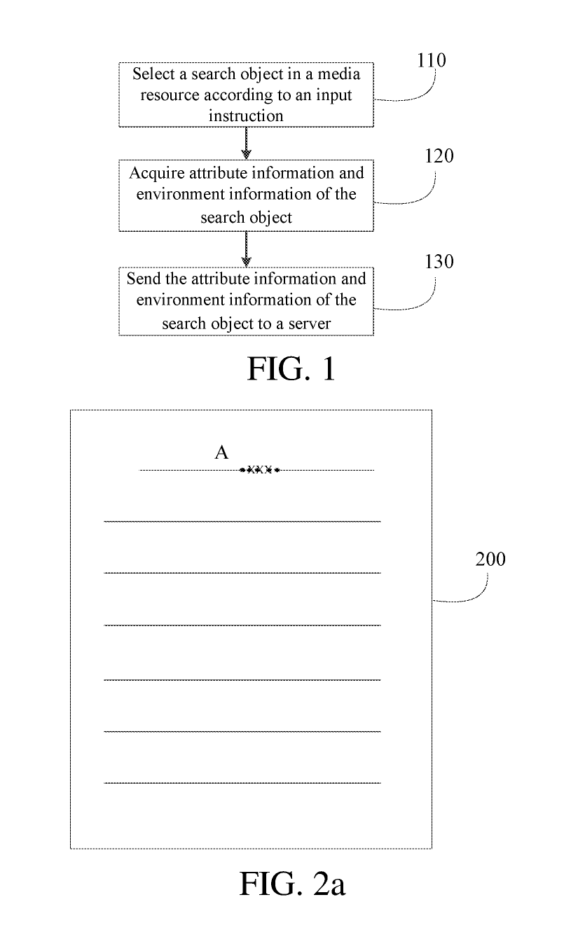

An embodiment of the present application provides a search method. As shown in FIG. 1, the method comprises:

110: Select a search object in a media resource according to an input instruction.

The input instruction is generally input by a user through an input unit of a terminal. The terminal herein may be a mobile terminal such as a smart phone, a tablet computer, or a notebook computer, and may also be a device such as a desktop computer. Correspondingly, the input unit herein may specifically be a device such as a keyboard, a touch screen, a mouse, or an image sensor. The search object may be text, an image, a video file, an audio file, or the like. For example, when browsing a web page by using a smart phone, a user may tap the touch screen of the smart phone to select a word on the web page as a search object, or when accessing a document on a cloud drive by using a tablet computer, a user may select, by using a mouse command, an image in the document as a search object.

120: Acquire attribute information and environment information of the search object.

The attribute information of the search object may be content of the search object or area information of the search object. The environment information of the search object may be a resource identity (ID) of the media resource to which the search object belongs, or a resource ID of the media resource to which the search object belongs and type information of a terminal that displays the search object, or type information of a terminal that displays the search object. The media resource to which the search object belongs may be a web page, a Word document, an Excel chart, a PowerPoint file, or the like; correspondingly, the resource ID is generally a universal resource identifier (URI) of a web page, a Word document, an Excel chart, a PowerPoint file, or the like. A URI of a web page is a universal resource locator (URL) of the web page. The type information of the terminal generally comprises information such as brand, model, and version number of the terminal, and type description information of the terminal can be acquired according to the type information of the terminal. The context of the search object may be calculated according to the content of the search object and the resource ID of the media resource to which the search object belongs; or, the content of the search object and the context of the search object may be calculated according to the area information of the search object, the resource ID of the media resource to which the search object belongs, and the type description information of the terminal that displays the search object.

130: Send the attribute information and environment information of the search object to a server.

The server may be merely a search server comprising a search engine, and may also be a comprehensive server which provides a search service and a data distribution service at the same time. When the server is merely a search server, the search server may accurately locate the media resource to which the search object belongs according to the resource ID of the media resource to which the search object belongs comprised in the environment information of the search object. When the server is a comprehensive server, the media resource to which the search object belongs is distributed by the comprehensive server. Therefore, the comprehensive server can automatically acquire the resource ID of the media resource to which the search object belongs. Based on the resource ID of the media resource to which the search object belongs, the attribute information of the search object, and other environment information besides the resource ID, the server can calculate the content of the search object and the context of the search object, thereby accomplishing a searching task, and sends a search result to the terminal.

In the method according to this embodiment, only attribute information and environment information of a search object are sent to a server, and the server side calculates content of the search object and context of the search object according to the attribute information and environment information of the search object, thereby accomplishing a searching task. It is avoided that both the content of the search object and the context of the search object are sent to the server. Therefore, data traffic is reduced while high search efficiency is ensured, and moreover, electric energy loss on the terminal side during data communication is reduced.

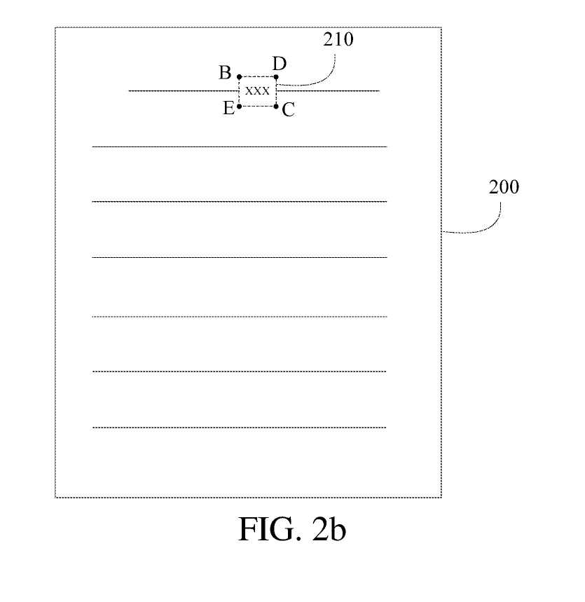

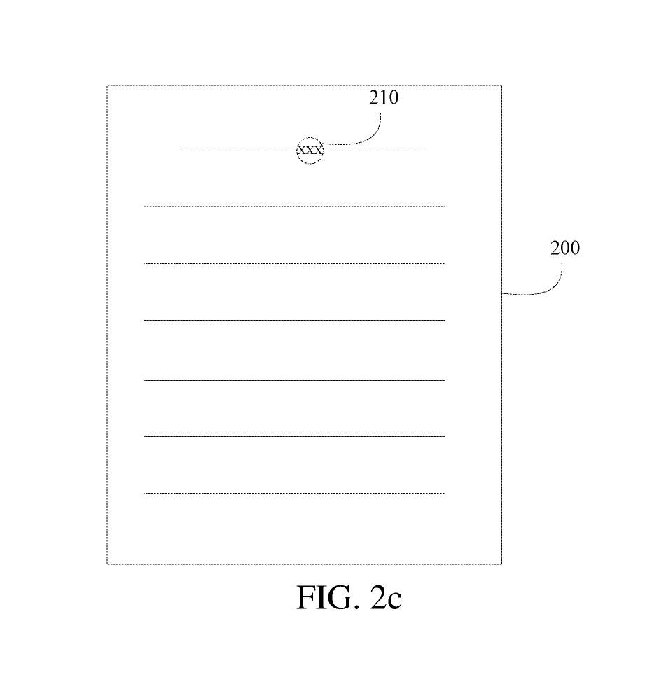

Specifically, the area information of the search object may be start coordinates of the search object in the media resource to which the search object belongs, and a length of the search object. FIG. 2a is a schematic diagram of a type of area information of a search object according to an embodiment of the present application. As shown in FIG. 2a, in a media resource 200 (such as a web page), start coordinates of the search object (namely, XXX) in the media resource to which the search object belongs are coordinates of pixel A in FIG. 2a; the length of the search object is the number of pixels from start to end the search object, and in FIG. 2a, the length of the search object is 5. In other words, the start coordinates of the search object are coordinates of the first pixel of the search object in the media resource to which the search object belongs, and the length of the search object is the number of pixels between the first pixel and the last pixel of the search object in the media resource to which the search object belongs.

The area information of the search object may also be opposite corner coordinates of the search object in the media resource to which the search object belongs. FIG. 2b is a schematic diagram of another type of area information of a search object according to an embodiment of the present application. As shown in FIG. 2b, in a media resource 200 (such as a web page), the block area surrounded by dashed lines is the area where the search object 210 is located. The opposite corner coordinates of the search object in the media resource to which the search object belongs are coordinates of point B and point C, or coordinates of point D and point E. In other words, the opposite corner coordinates of the search object in the media resource to which the search object belongs are coordinates of two endpoints of one of the diagonal lines of a minimum rectangle comprising the search object.

The area information of the search object may also be center coordinates and a radius of the search object in the media resource to which the search object belongs. FIG. 2c is a schematic diagram of still another type of area information of a search object according to an embodiment of the present application. As shown in FIG. 2c, in a media resource 200 (such as a web page), the circular area surrounded by a dashed line is the area where the search object 210 is located. The center coordinates of the search object in the media resource to which the search object belongs are coordinates of the center of the circular area surrounded by the dashed line, and the radius of the search object in the media resource to which the search object belongs is also the radius of the circular area surrounded by the dashed line. In other words, the center coordinates of the search object in the media resource to which the search object belongs are coordinates of the center of a minimum circle comprising the search object, and the radius of the search object in the media resource to which the search object belongs is the radius of the minimum circle.

In addition, apart from the foregoing specific forms of the area information, the area information of the search object may also be in another form, for example, coordinates of three vertices of a minimum triangle comprising the search object; or focal coordinates, a length of the major axis, and a length of the minor axis of a minimum ellipse comprising the search object; or a coordinate sequence comprising the search object.

An image, a video file, or an audio file generally has a large size, and therefore, when such manner in which the terminal sends the area information of the search object to the server and the server determines the content of the search object through calculation is applied to the search of non-text files such as an image, a video file, and an audio file, data traffic can be reduced more effectively.

To ensure high efficiency of the search, apart from sending the attribute information of the search object to the server, the terminal further needs to send the environment information of the search object to the server, so that the server can search based on the context of the search object, to obtain a search result needed by the user.

The environment information of the search object may be a resource ID of the media resource to which the search object belongs. The resource ID may be a URI, and generally comprises: universal file IDs (such as a File Transfer Protocol (FTP) address) applicable to various network servers or a web page ID (generally a URL); besides, the resource ID may also be a file ID using a predetermined marking manner on a predetermined cloud server. When the attribute information of the search object is content of the search object, the environment information of the search object only needs to comprise a resource ID of the media resource to which the search object belongs. In this way, after receiving the attribute information and environment information of the search object, the server can acquire the media resource to which the search object belongs according to the resource ID, and obtain context of the search object through calculation with reference to the content of the search object, thereby accomplishing context-based searching.

The environment information of the search object may also be a resource ID of the media resource to which the search object belongs and type information of a terminal that displays the search object. When the attribute information of the search object is area information of the search object, the server cannot directly acquire content of the search object from the terminal. Therefore, the server needs to obtain, according to the resource ID of the media resource to which the search object belongs and the type information of the terminal that displays the search object, a display layout comprising the search object, thereby acquiring the content and context of the search object through calculation with reference to the area information of the search object. Generally, the server may automatically acquire type description information of the terminal according to the type information of the terminal, for example, the server may acquire type description information corresponding to the type information of the terminal by means of searching on the Internet, or the terminal automatically uploads the type information and corresponding type description information thereof when a client is installed on the terminal or the terminal is connected to the server for the first time, and the server may acquire the corresponding type description information by searching a local memory according to the type information of the terminal. The type description information comprises: at least one of a default cascading style sheet (CSS) file, a font, and parameter related information of the terminal.

When the server to which the terminal is connected is a comprehensive server that provides the terminal with a data distribution service and a search service at the same time, the environment information of the search object may be merely type information of a terminal that displays the search object. Because a media resource currently browsed by the terminal is sent by the comprehensive server, the comprehensive server may automatically acquire the resource ID of the media resource to which the search object belongs, then with reference to the type information of the terminal that displays the search object, the server can obtain a display layout comprising the search object, thereby acquiring the content and context of the search object through calculation with reference to the area information of the search object.

In addition, the environment information of the search object may further comprise information such as a position of the terminal, an ambient temperature, and ambient humidity.

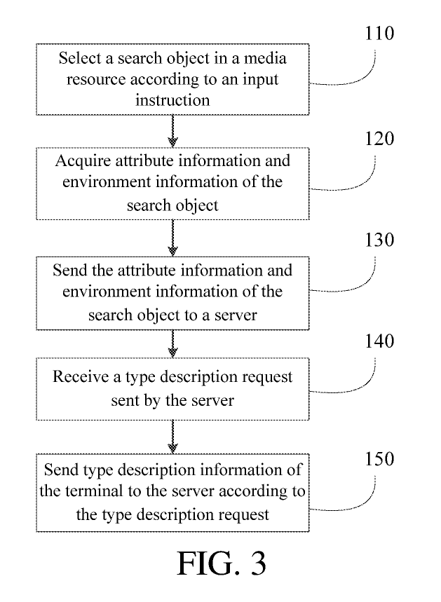

During an application process, the server may fail to recognize the type information sent by the server, for example, the type information of the terminal is not common and the terminal does not upload corresponding type description information previously. In this case, the server may send a type description request to the terminal, so as to request the terminal to describe the type information. Therefore, referring to FIG. 3, the method further comprises:

140: Receive a type description request sent by the server.

150: Send type description information of the terminal to the server according to the type description request.

As described above, the type description information may comprise: a default CSS file, a font, and parameter related information of the terminal. The default CSS file is mainly used in a case in which the media resource to which the search object belongs is a web page, and the server can obtain a CSS file corresponding to the search object according to the default CSS file and an embedded CSS file of the web page. The parameter related information may be parameter information of the terminal, and may also be a screenshot of the terminal; the server may carry out analysis according to the screenshot, to obtain parameter information of the terminal. When the media resource to which the search object belongs is a web page, the terminal may obtain, according to the URL of the web page, the CSS file corresponding to the search object, and the font and parameter information of the terminal, a display layout comprising the search object. When the media resource to which the search object belongs is a media resource other than a web page, the terminal may obtain, according to the resource ID corresponding to the media resource, and the font and parameter information of the terminal, a display layout comprising the search object.

The parameter information of the terminal refers to information such as a screen size and resolution of the terminal.

When the parameter related information of the terminal is parameter information of the terminal, the method further comprises:

Receive user input to acquire parameter information of the terminal.

When the parameter related information of the terminal is a screenshot of the terminal, the method further comprises:

Acquire a screenshot of the terminal, and use the screenshot as the parameter related information of the terminal.

In addition, the embodiments of the present application also provide a computer readable storage medium, comprising at least one executable instruction, which perform the following operations when being executed: executing the operations of S110, S120 and S130 of the method in the implementation shown in FIG. 1.

In conclusion, in the search method according to the embodiment of the present application, a terminal only sends attribute information and environment information of a search object to a server, and the search object and context of the search object are determined through calculation by taking full advantage of a computing capability of the server, which reduces data traffic between the terminal and the server while ensuring high search efficiency.

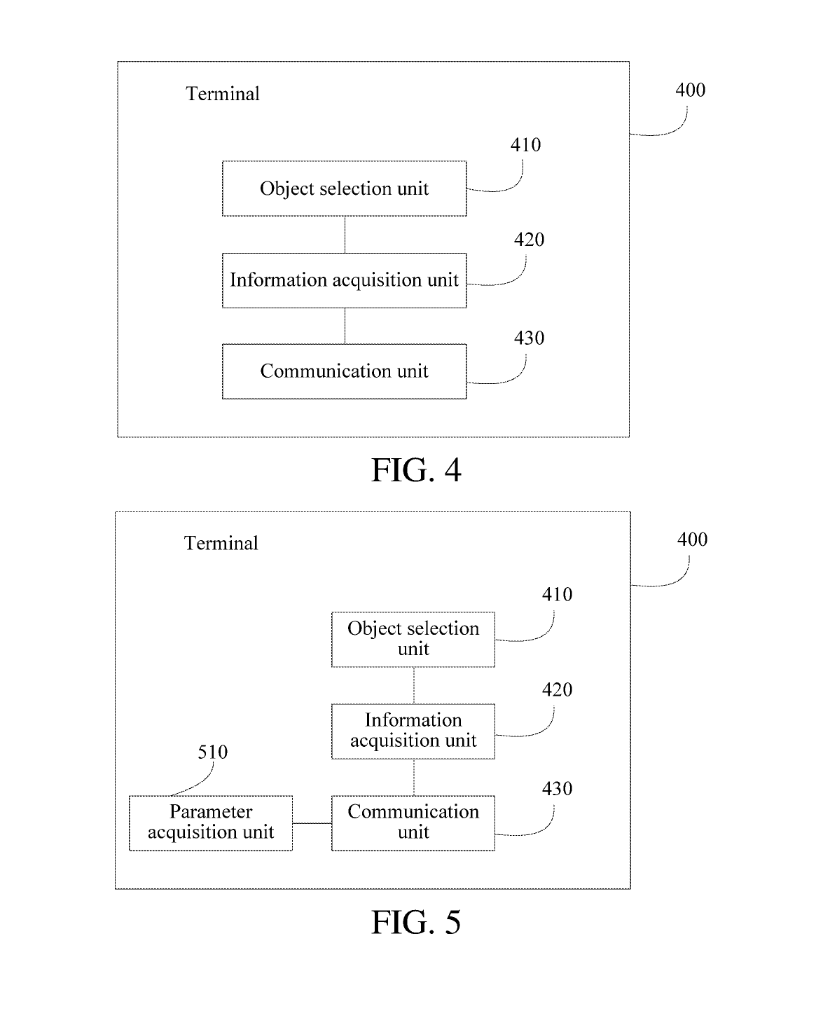

FIG. 4 is a schematic structural diagram of modules of a search terminal according to an embodiment of the present application. The terminal 400 may be a mobile device such as a smart phone, a tablet computer, or a notebook computer, and may also be a device such as a desktop computer. As shown in FIG. 4, the terminal 400 comprises:

an object selection unit 410, configured to select a search object in a media resource according to an input instruction, where

the input instruction is generally input by a user through an input unit of the terminal; the input unit herein may specifically be a device such as a keyboard, a touch screen, a mouse, or an image sensor; the search object may be text, an image, a video file, an audio file, or the like; for example, when browsing a web page by using a smart phone, a user may tap the touch screen of the smart phone to select a word on the web page as a search object, or when accessing a document on a cloud drive by using a tablet computer, a user may select, by using a mouse command, an image in the document as a search object;

an information acquisition unit 420, configured to acquire attribute information and environment information of the search object, where

the attribute information of the search object may be content of the search object or area information of the search object; the environment information of the search object may be a resource ID of the media resource to which the search object belongs, or a resource ID of the media resource to which the search object belongs and type information of a terminal that displays the search object, or type information of a terminal that displays the search object; the media resource to which the search object belongs may be a web page, a Word document, an Excel chart, a PowerPoint file, or the like; correspondingly, the resource ID is generally a URI of a web page, a Word document, an Excel chart, a PowerPoint file, or the like; a URI of a web page is a URL of the web page; the type information of the terminal generally comprises information such as brand and model of the terminal, and type description information of the terminal may be acquired according to the type information of the terminal generally; the context of the search object may be calculated according to the content of the search object and the resource ID of the media resource to which the search object belongs; or, the content of the search object and the context of the search object may be calculated according to the area information of the search object, the resource ID of the media resource to which the search object belongs, and the type description information of the terminal that displays the search object; and

a communication unit 430, configured to send the attribute information and environment information of the search object to a server.

The server may be merely a search server comprising a search engine, and may also be a comprehensive server which provides a search service and a data distribution service at the same time. When the server is merely a search server, the search server can accurately locate the media resource to which the search object belongs according to the resource ID of the media resource to which the search object belongs comprised in the environment information of the search object. When the server is a comprehensive server, the media resource to which the search object belongs is distributed by the comprehensive server. Therefore, the comprehensive server can automatically acquire the resource ID of the media resource to which the search object belongs. Based on the resource ID of the media resource to which the search object belongs, the attribute information of the search object, and other environment information besides the resource ID, the server can calculate the content of the search object and the context of the search object, thereby accomplishing a searching task, and sends a search result to the terminal.

The terminal according to this embodiment only sends attribute information and environment information of a search object to a server, and the server side calculates content of the search object and context of the search object according to the attribute information and environment information of the search object, thereby accomplishing a searching task. It is avoided that both the content of the search object and the context of the search object are sent to the server. Therefore, data traffic is reduced while high search efficiency is ensured, and electric energy loss on the terminal side during data communication is reduced.

Specifically, the area information of the search object may be start coordinates of the search object in the media resource to which the search object belongs, and a length of the search object. Referring to FIG. 2a, in a media resource 200 (such as a web page), start coordinates of the search object (namely, XXX) in the media resource to which the search object belongs are coordinates of pixel A in FIG. 2a; the length of the search object is the number of pixels from start to end the search object, and in FIG. 2a, the length of the search object is 5. In other words, the start coordinates of the search object are coordinates of the first pixel of the search object in the media resource to which the search object belongs, and the length of the search object is the number of pixels between the first pixel and the last pixel of the search object in the media resource to which the search object belongs.

The area information of the search object may also be opposite corner coordinates of the search object in the media resource to which the search object belongs. Referring to FIG. 2b, in a media resource 200 (such as a web page), the block area surrounded by dashed lines is the area where the search object 210 is located. The opposite corner coordinates of the search object in the media resource to which the search object belongs are coordinates of point B and point C, or coordinates of point D and point E. In other words, the opposite corner coordinates of the search object in the media resource to which the search object belongs are coordinates of two endpoints of one of the diagonal lines of a minimum rectangle comprising the search object.

The area information of the search object may also be center coordinates and a radius of the search object in the media resource to which the search object belongs. Referring to FIG. 2c, in a media resource 200 (such as a web page), the circular area surrounded by a dashed line is the area where the search object 210 is located. The center coordinates of the search object in the media resource to which the search object belongs are coordinates of the center of the circular area surrounded by the dashed line, and the radius of the search object in the media resource to which the search object belongs is also the radius of the circular area surrounded by the dashed line. In other words, the center coordinates of the search object in the media resource to which the search object belongs are coordinates of the center of a minimum circle comprising the search object, and the radius of the search object in the media resource to which the search object belongs is the radius of the minimum circle.

In addition, apart from the foregoing specific forms of the area information, the area information of the search object may also be in another form, for example, coordinates of three vertices of a minimum triangle comprising the search object; or focal coordinates, a length of the major axis, and a length of the minor axis of a minimum ellipse comprising the search object; or a coordinate sequence comprising the search object.

An image, a video file, or an audio file generally has a large size, and therefore, when the terminal is applied to the search of non-text files such as an image, a video file, and an audio file, data traffic can be reduced more effectively.

To ensure high efficiency of the search, apart from sending the attribute information of the search object to the server, the terminal further needs to send the environment information of the search object to the server, so that the server can search based on the context of the search object, to obtain a search result needed by the user.

The environment information of the search object may be a resource ID of the media resource to which the search object belongs. The resource ID may be a URI, and generally comprises: universal file IDs (such as an FTP address) applicable to various network servers or a web page ID (generally a URL); besides, the resource ID may also be a file ID using a predetermined marking manner on a predetermined cloud server. When the attribute information of the search object is content of the search object, the environment information of the search object only needs to comprise a resource ID of the media resource to which the search object belongs. In this way, after receiving the attribute information and environment information of the search object, the server can acquire the media resource to which the search object belongs according to the resource ID, and obtain context of the search object through calculation with reference to the content of the search object, thereby accomplishing context-based searching.

The environment information of the search object may also be a resource ID of the media resource to which the search object belongs and type information of the terminal. When the attribute information of the search object is area information of the search object, the server cannot directly acquire content of the search object from the terminal. Therefore, the server needs to obtain, according to the resource ID of the media resource to which the search object belongs and the type information of the terminal, a display layout comprising the search object, thereby acquiring the content and context of the search object through calculation with reference to the area information of the search object. Generally, the server may automatically acquire type description information of the terminal according to the type information of the terminal, for example, the server may acquire type description information corresponding to the type information of the terminal by means of searching on the Internet, or the terminal automatically uploads the type information and corresponding type description information thereof when a client is installed on the terminal or the terminal is connected to the server for the first time, and the server may acquire the corresponding type description information by searching a local memory according to the type information of the terminal. The type description information comprises: at least one of a default CSS file, a font, and parameter related information of the terminal.

When the server to which the terminal is connected is a comprehensive server that provides the terminal with a data distribution service and a search service at the same time, the environment information of the search object may be merely type information of the terminal. Because a media resource currently browsed by the terminal is sent by the comprehensive server, the comprehensive server may automatically acquire the resource ID of the media resource to which the search object belongs, then with reference to the type information of the terminal, the server can obtain a display layout comprising the search object, thereby acquiring the content and context of the search object through calculation with reference to the area information of the search object.

During an application process, the server may fail to recognize the type information sent by the server, for example, the type information of the terminal is not common and the terminal does not upload corresponding type description information previously. In this case, the server may send a type description request to the terminal, so as to request the terminal to describe the type information. Therefore, the communication unit 430 is further configured to receive a type description request sent by the server, and send type description information of the terminal 400 to the server according to the type description request.

As described above, the type description information may comprise: a default CSS file, a font, and parameter related information of the terminal. The default CSS file is mainly used in a case in which the media resource to which the search object belongs is a web page, and the server can obtain a CSS file corresponding to the search object according to the default CSS file and an embedded CSS file of the web page. The parameter related information may be parameter information of the terminal, and may also be a screenshot of the terminal; the server may carry out analysis according to the screenshot, to obtain parameter information of the terminal. When the media resource to which the search object belongs is a web page, the terminal may obtain, according to the URL of the web page, the CSS file corresponding to the search object, and the font and parameter information of the terminal, a display layout comprising the search object. When the media resource to which the search object belongs is a media resource other than a web page, the terminal may obtain, according to the resource ID corresponding to the media resource, and the font and parameter information of the terminal, a display layout comprising the search object.

The parameter information of the terminal refers to information such as a screen size and resolution of the terminal.

Referring to FIG. 5, when the parameter related information of the terminal is parameter information of the terminal, the terminal further comprises:

a parameter acquisition unit 510, configured to receive user input to acquire parameter information of the terminal.

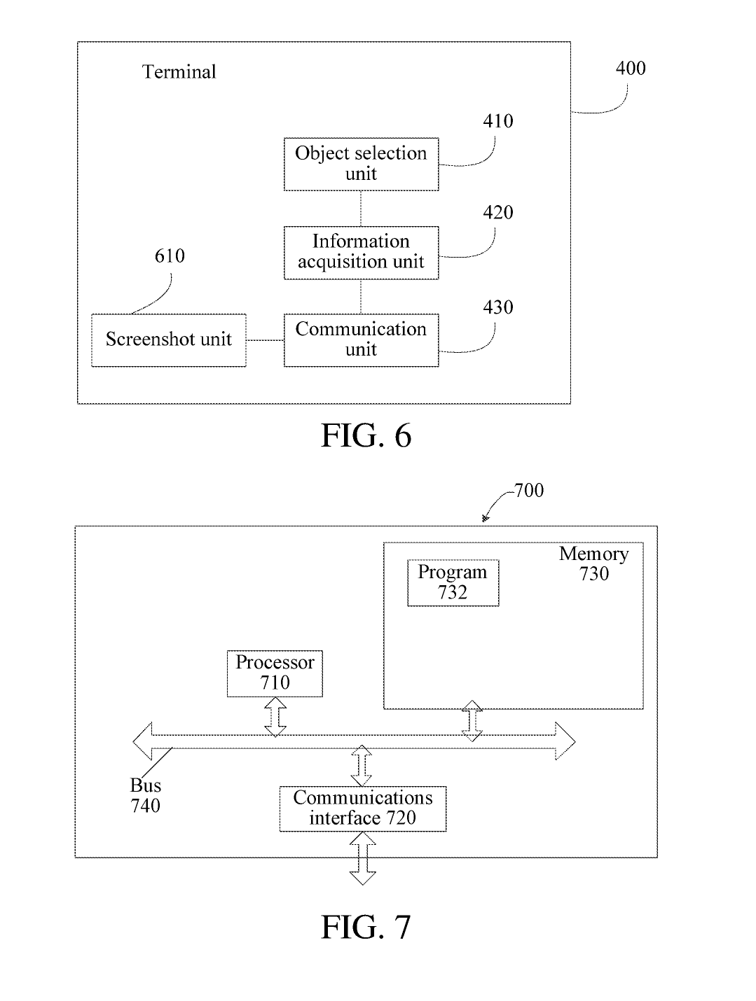

Referring to FIG. 6, when the parameter related information of the terminal is a screenshot of the terminal, the terminal further comprises:

a screenshot unit 610, configured to acquire a screenshot of the terminal, and use the screenshot as the parameter related information of the terminal.

In conclusion, the search terminal according to the embodiment of the present application only sends attribute information and environment information of a search object to a server, and the search object and context of the search object are determined through calculation by taking full advantage of a computing capability of the server, which reduces data traffic between the terminal and the server while ensuring high search efficiency.

FIG. 7 is a schematic structural diagram of hardware of a search terminal according to an embodiment of the present application. The embodiment of the present application does not limit the specific implementation of the search terminal. As shown in FIG. 7, the terminal may comprise:

a processor 710, a communications interface 720, a memory 730, and a communication bus 740.

The processor 710, the communications interface 720, and the memory 730 communicate with each other through the communication bus 740.

The communications interface 720 is configured to communicate with a server.

The processor 710 is configured to execute a program 732, and may specifically execute method embodiments shown in FIG. 1 and FIG. 3.

Specifically, the program 732 may comprise program code, and the program code comprises a computer instruction.

The processor 710 may be a central processing unit (CPU), or an application specific integrated circuit (ASIC), or may be configured as one or more integrated circuits for implementing the embodiment of the present application.

The memory 730 is configured to store the program 732. The memory 730 may comprise a high-speed random access memory (RAM), and may also comprise a non-volatile memory, for example, at least one disk memory. The program 732 particularly can execute a method, comprising:

selecting a search object in a media resource according to an input instruction;

acquiring attribute information and environment information of the search object; and

sending the attribute information and environment information of the search object to a server.

For specific implementation of each unit in the program 732, reference may be made to corresponding unit in the embodiment shown in FIG. 4, and details are not described herein again. It can be clearly understood by a person skilled in the art that, to make the description easy and precise, for a detailed working process of the foregoing devices and units, reference may be made to the corresponding process description in the foregoing method embodiment, and details are not described herein again.

A person of ordinary skill in the art may realize that, the units and methods of examples described in the embodiments disclosed herein can be implemented by electronic hardware, or a combination of computer software and electronic hardware. Whether these functions are executed by hardware or software depends upon the particular application and design constraint conditions of the technical solution. A person skilled in the art can use different methods to implement the described functions for each particular application, but such implementation should not be regarded as beyond the scope of the present application.

If implemented in the form of software functional units and sold or used as an independent product, the functions may be stored in a computer readable storage medium, or computer readable storage device. Based on such understanding, essence of the technical solution of the present application, or the part that makes contributions to the prior art, or a part of the technical solution can be embodied in the form of a software product. The computer software product may be stored in a storage medium and comprise several instructions for instructing a computer device (for example, a personal computer, a server, or a network device) to execute all or a part of the methods according to the embodiments of the present application. The foregoing storage medium comprises: any medium capable of storing program code, such as a USB flash disk, a removable hard disk, a read-only memory (ROM), a RAM, a magnetic disk, or an optical disc.

The foregoing implementation manners are merely used for describing the present application rather than limiting the present application. A person of ordinary skill in the art may make various modifications and variations without departing from the spirit and scope of the various embodiments of the present application, and all the equivalent technical solutions also belong to the scope of the various embodiments of the present application. The patent protection scope of the present application shall be subject to the claims.

1. A method, comprising:
selecting, by a device comprising a processor, a search object in a media resource according to an input instruction;
acquiring attribute information and environment information of the search object; and
sending the attribute information and the environment information of the search object to a server.

2. The method of claim 1, wherein the attribute information of the search object comprises area information of the search object.

3. The method of claim 2, wherein the area information of the search object comprises start coordinates of the search object in the media resource to which the search object belongs, and a length of the search object.

4. The method of claim 2, wherein the area information of the search object comprises opposite corner coordinates of the search object in the media resource to which the search object belongs.

5. The method of claim 2, wherein the area information of the search object comprises center coordinates and a radius of the search object in the media resource to which the search object belongs.

6. The method of claim 1, wherein the attribute information of the search object comprises content of the search object.

7. The method of claim 1, wherein the environment information of the search object comprises: a resource identity (ID) of the media resource to which the search object belongs.

8. The method of claim 1, wherein the environment information of the search object comprises: a resource identity (ID) of the media to which the search object belongs and type information of a terminal that displays the search object.

9. The method of claim 7, wherein the resource ID is a universal resource identifier (URI).

10. The method of claim 8, wherein the resource ID is a universal resource identifier (URI).

11. The method of claim 1, wherein the environment information of the search object comprises type information of a terminal that displays the search object.

12. The method of claim 8, further comprising:
receiving a type description request sent by the server; and
sending type description information of the terminal to the server according to the type description request.

13. The method according to claim 12, wherein the type description information of the terminal comprises: at least one of a default cascading style sheet (CSS) file, a font, and parameter related information of the terminal.

14. The method according to claim 13, wherein the parameter related information of the terminal is: parameter information of the terminal;
the method further comprising:
receiving user input to acquire parameter information of the terminal.

15. The method according to claim 14, wherein the parameter information of the terminal comprises: at least one of a screen size and resolution of the terminal.

16. The method according to claim 13, further comprising:
acquiring a screenshot of the terminal.

17. The method according to claim 16, further comprising:
using the screenshot as the parameter related information of the terminal.

18. The method according to claim 1, wherein the search object comprises: at least one of text, an image, a video file, and an audio file.

19. A terminal, comprising:
a memory that stores executable units; and
a processor, coupled to the memory, that executes the executable units to perform operations of the terminal, the executable units comprising:
an object selection unit configured to select a search object in a media resource according to an input instruction;
an information acquisition unit configured to acquire attribute information and environment information of the search object; and
a communication unit configured to send the attribute information and the environment information of the search object to a server.

20. The terminal of claim 19, wherein the attribute information of the search object comprises area information of the search object.

21. The terminal of claim 20, wherein the area information of the search object comprises start coordinates of the search object in the media resource to which the search object belongs, and a length of the search object.

22. The terminal of claim 20, wherein the area information of the search object comprises opposite corner coordinates of the search object in the media resource to which the search object belongs.

23. The terminal of claim 20, wherein the area information of the search object comprises center coordinates and a radius of the search object in the media resource to which the search object belongs.

24. The terminal of claim 19, wherein the attribute information of the search object comprises content of the search object.

25. The terminal of claim 19, wherein the environment information of the search object comprises a resource identity (ID) of the media resource to which the search object belongs.

26. The terminal of claim 19, wherein the environment information of the search object comprises a resource identity (ID) of the media to which the search object belongs and type information of a terminal that displays the search object.

27. The terminal of claim 25, wherein the resource ID is a universal resource identifier (URI).

28. The terminal of claim 26, wherein the resource ID is a universal resource identifier (URI).

29. The terminal of claim 19, wherein the environment information of the search object comprises type information of a terminal that displays the search object.

30. The terminal of claim 26, wherein the communication unit is further configured to receive a type description request sent by the server, and send type description information of the terminal to the server according to the type description request.

31. The terminal of claim 29, wherein the communication unit is further configured to receive a type description request sent by the server, and
send type description information of the terminal to the server according to the type description request.

32. The terminal of claim 31, wherein the type description information of the terminal comprises at least one of a default cascading style sheet file, a font, or parameter related information of the terminal.

33. The terminal of claim 32, wherein the parameter related information of the terminal is: parameter information of the terminal, and
the executable units further comprise:
a parameter acquisition unit configured to receive user input to acquire parameter information of the terminal.

34. The terminal of claim 33, wherein the parameter information of the terminal comprises at least one of a screen size or a resolution of the terminal.

35. The terminal of claim 32, wherein the executable units further comprise:
a screenshot unit configured to acquire a screenshot of the terminal, and use the screenshot as the parameter related information of the terminal.

36. The terminal of claim 19, wherein the search object comprises at least one of text, an image, a video file, or an audio file.

37. A computer readable storage device, comprising at least one executable instruction, which, in response to execution, causes a terminal comprising a processor to perform operations, comprising:
selecting a search object in a media resource according to an input instruction;
acquiring attribute information and environment information of the search object; and
sending the attribute information and the environment information of the search object to a server.

38. A search terminal, comprising a processor and a memory, the memory storing computer executable instructions, the processor being connected to the memory via a communication bus, and when the search terminal operates, the processor executes the computer executable instructions stored in the memory, so that the search terminal executes operations, comprising:
selecting a search object in a media resource according to an input instruction;
acquiring attribute information and environment information of the search object; and
sending the attribute information and the environment information of the search object to a server.
